(19) United States
(12) Patent Application Publication
(10) Pub. No.: US 2004/0231904 A1
(43) Pub. Date: Nov. 25, 2004

(54) System and method for actively controlling traction in an articulated vehicle

(76) Inventors: Michael S. Beck, Colleyville, TX (US); Kevin L. Conrad, Mansfield, TX (US)

Correspondence Address: Daren C. Davis, Williams, Morgan & Amerson, P.C., 10333 Richmond, Suite 1100, Houston, TX, 77042, US

(21) Appl. No.: 10/784,739

(22) Filed: Feb. 23, 2004

Related U.S. Application Data
(60) Provisional application No. 60/449,271, filed on Feb. 21, 2003.

(51) Int. Cl. B60K 1/00

(52) U.S. Cl. 180/197

(57) ABSTRACT

A method of controlling traction in a vehicle having an articulated suspension includes determining a performance characteristic of the vehicle; determining a performance characteristic of at least one of a plurality of wheel assemblies of the articulated suspension; comparing the performance characteristic of the vehicle and the performance characteristic of the at least one of the plurality of wheel assemblies; and altering the performance of the vehicle based upon the comparison to affect the vehicle's traction. A method of controlling traction in a vehicle having an articulated suspension includes determining a load on each of a plurality of wheel assemblies of the articulated suspension and adjusting the articulated suspension such that each of the loads is within a predetermined range.

The earlier effective filing date is claimed of co-pending U.S. Provisional Application Ser. No. 60/449,271, entitled “Unmanned Ground Vehicle,” filed Feb. 21, 2003, in the name of Michael S. Beck, et al. (Docket No. 2063.005190/VS-00607), for all common subject matter. Further, the earlier effective filing date is claimed of co-pending U.S. application Ser. No. 10/639,278, entitled “Vehicle Having an Articulated Suspension and Method of Using Same”, filed Aug. 12, 2003, in the name of Michael S. Beck et al. (Docket No. 2063.004600/VS-00582), for all common subject matter.

### BACKGROUND OF THE INVENTION

1. Field of the Invention

This invention relates to a vehicle traction control system and, in particular, to a traction control system for vehicle having an articulated suspension and a method of controlling the traction of the vehicle.

2. Description of the Related Art

The ability of a vehicle to traverse over terrain relies directly upon the vehicle's traction on the terrain. If the vehicle's tire turns with a force greater than the friction between the tire and the terrain, the tire will spin, causing the vehicle to lose traction. If the vehicle's tire turns with a force that is greater than the strength of the material making up the terrain, the terrain material will be displaced, causing the vehicle to lose traction. For example, a sand/clay terrain will have a greater strength than a loose sand terrain, as the clay adhesively bonds the sand grains together. For the vehicle to maintain traction, the force imparted on the terrain by the turning tire must be less than the friction between the tire and the terrain and less than the strength of the material making up the terrain.

Controlling traction in articulated vehicles, i.e., vehicles having articulated suspensions, presents problems not faced by controlling traction in conventional wheeled vehicles due to their articulated suspensions. One significant problem is maintaining ground contact with multiple independent drive systems. As in conventionally suspended vehicles, terrain interaction and vehicle attitude can prevent suspended elements from contacting the ground plane, either due to frame/body rigidity or suspension travel limitations. The problem can be further exacerbated with articulated suspensions, which allow for raising and lowering of the drive systems, when the systems are in a raised mode.

Further, articulated vehicles are particularly adapted for use in off-road environments. One particular problem is traversing multiple types of terrain at the same time. For instance, at a river crossing, the vehicle's tires may be on dry rock, wet rock, mud, and gravel at the same time.

The present invention is directed to overcoming, or at least reducing, the effects of one or more of the problems set forth above.

### SUMMARY OF THE INVENTION

In one aspect of the present invention, a method of controlling traction in a vehicle having an articulated suspension is provided. The method includes:

determining a performance characteristic of the vehicle

determining a performance characteristic of at least one of a plurality of wheel assemblies of the articulated suspension;

comparing the performance characteristic of the vehicle and the performance characteristic of the at least one of the plurality of wheel assemblies; and

altering the performance of the vehicle based upon the comparison to affect the vehicle's traction.

In another aspect of the present invention, a method of controlling traction in a vehicle having an articulated suspension is provided. The method includes:

determining a load on each of a plurality of wheel assemblies of the articulated suspension; and

adjusting the articulated suspension such that each of the loads is within a predetermined range.

In yet another aspect of the present invention, a method of controlling traction in a vehicle having an articulated suspension is provided, including:

acquiring load data for a plurality of wheel assemblies of the articulated suspension;

identifying a lightly loaded wheel assembly of the plurality of wheel assemblies from the load data; and

articulating the lightly loaded wheel assembly with respect to a chassis of the vehicle.

In another aspect of the present invention, a method of controlling traction in a vehicle having an articulated suspension is provided, including:

determining whether forces on each of a plurality of wheel assemblies of the articulated suspension are substantially equal;

determining whether a rotational velocity of each tire of the plurality of wheel assemblies corresponds to a velocity of the vehicle; and

adjusting the articulated suspension such that each of the forces is within a predetermined range if the forces are not substantially equal and at least one of the rotational velocities fails to correspond to the velocity of the vehicle.

In yet another aspect of the present invention, a method of controlling traction in a vehicle having an articulated suspension is provided. The method includes:

determining whether a rotational velocity of each tire of a plurality of wheel assemblies of the articulated suspension corresponds to a velocity of the vehicle; and

reducing the rotational velocity of one of the tires if the one of the tires has a determined rotational velocity that is greater than that which corresponds to the velocity of the vehicle.

In another aspect of the present invention, a system for controlling traction in an vehicle having an articulated suspension is provided, including:

means for sensing a loss of traction; and

means for adjusting the articulated suspension to regain traction.

In yet another aspect of the present invention, a vehicle is provided, including:

a chassis;

an articulated suspension mounted to the chassis;

means for sensing a loss of traction; and

means for adjusting the articulated suspension to regain traction.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIGS. 1A-1C are stylized, side elevational, end elevational, and top plan views, respectively, of an illustrative embodiment of a vehicle according to the present invention;

FIGS. 2A-2B are partial cross-sectional and exploded views, respectively, of an illustrative embodiment of a shoulder joint of the vehicle of FIGS. 1A-1C;

FIGS. 3A-3C are pictorial views of an illustrative embodiment of a locking mechanism for the shoulder joint of FIGS. 2A-2B;

FIG. 4 is a pictorial view of an illustrative embodiment of the vehicle of FIGS. 1A-1C;

FIGS. 5A-5B are pictorial and cross-sectional views, respectively, of an illustrative embodiment of an active damper for use with the shoulder joint of FIGS. 2A-2B;

FIG. 5C is an enlarged, cross-sectional view of a portion of the damper of FIG. 5B;

FIGS. 6A-6B are pictorial and exploded pictorial views, respectively, of an illustrative embodiment of a wheel assembly of the vehicle of FIGS. 1A-1C and FIG. 4;

FIG. 7A is a cross-sectional view of an illustrative embodiment of a hub drive of the wheel assembly of FIGS. 6A-6B in park mode;

FIG. 7B is an enlarged view of a portion of the hub drive of FIG. 7A;

FIGS. 8-10 are cross-sectional views of the hub drive of FIG. 7A in high speed, neutral, and low speed modes, respectively;

FIG. 11 is a flow chart of an illustrative embodiment of a method of controlling traction in an articulated vehicle;

FIG. 12 is a flow chart of an illustrative embodiment of a method of controlling traction in an articulated vehicle;

FIG. 13 is a flow chart of an illustrative embodiment of a method for controlling traction in an articulated vehicle on generally homogeneous, soft terrain;

FIG. 14 is a flow chart of an illustrative embodiment of a method for controlling traction in an articulated vehicle on generally homogeneous, hard terrain;

FIG. 15 is a flow chart of an illustrative embodiment of a method for controlling traction in an articulated vehicle on heterogeneous terrain;

FIG. 16 is a stylized block diagram of an illustrative embodiment of a system for controlling traction in an articulated vehicle according to the present invention; and

FIGS. 17A-17B are stylized views of a vehicle according to the present invention including a linearly articulable suspension.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The present invention pertains to actively controlling the traction of a ground vehicle, and, more particularly, to actively controlling the traction of an unmanned ground vehicle having an articulated suspension (i.e., an “articulated vehicle”). The embodiments illustrated herein correspond to unmanned ground combat vehicles, but the invention is not so limited. Indeed, some aspects of the invention are not limited even to unmanned ground vehicles, but may be applied to any ground vehicle. The design of a particular embodiment of an unmanned, ground vehicle will first be discussed, followed by a discussion of a traction control methodology and a system for controlling the traction of the vehicle, each according to the present invention.

### I. DESIGN OF THE VEHICLE

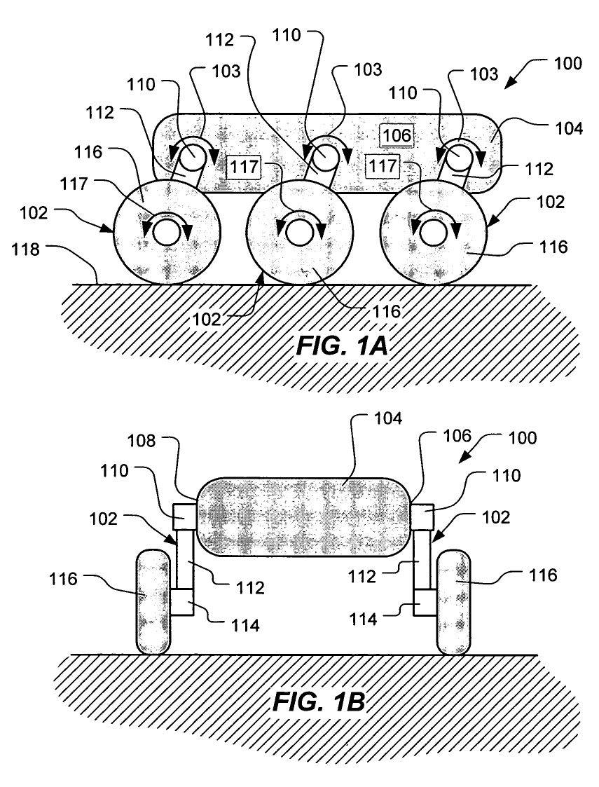

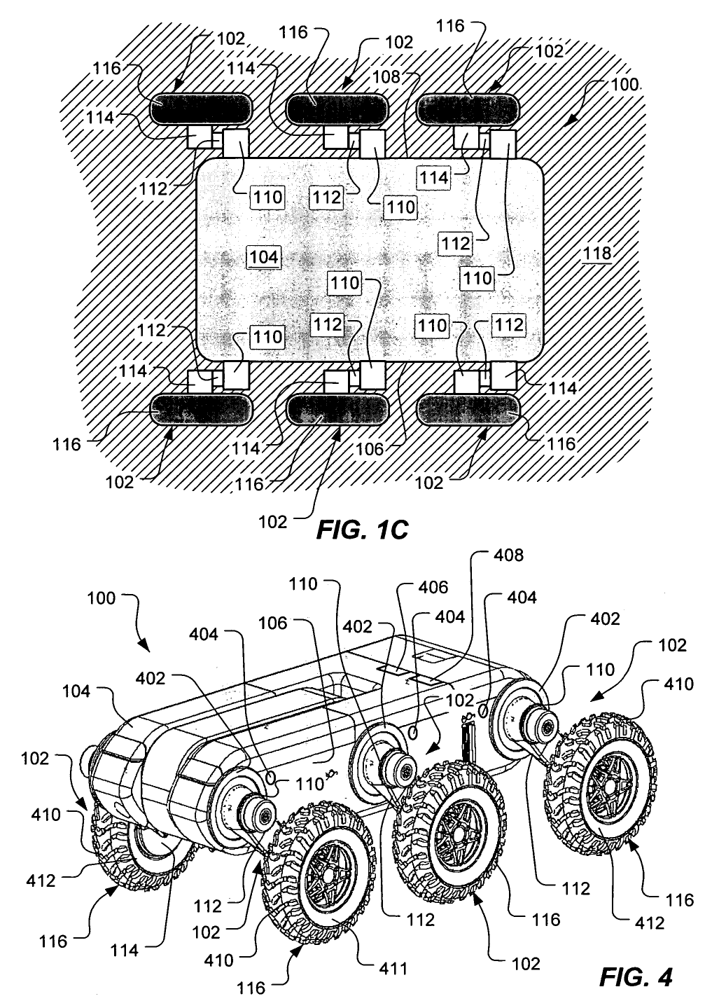

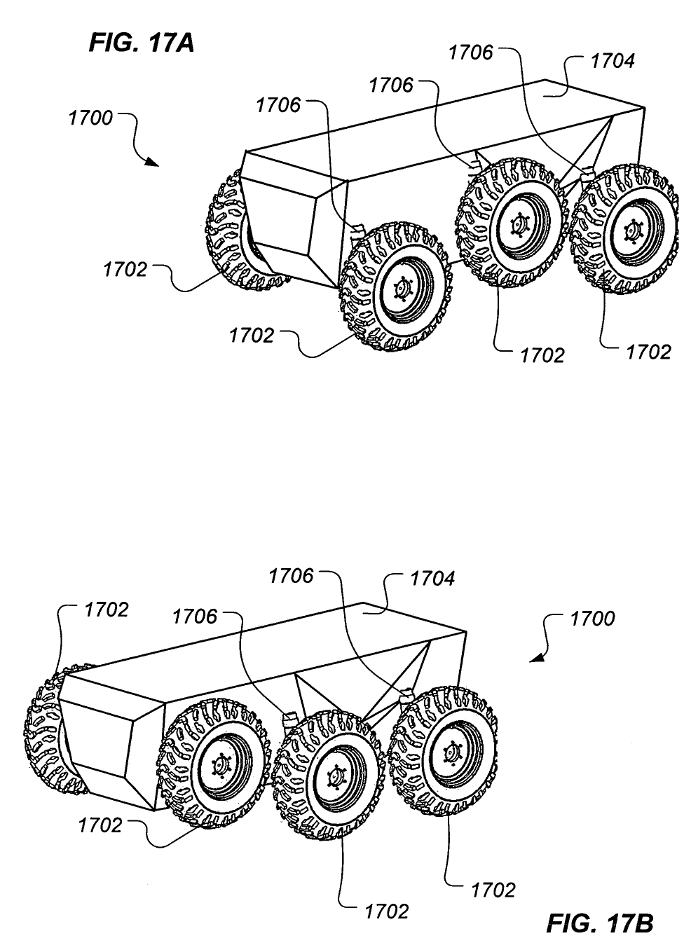

FIG. 1A-FIG. 1C are a side elevational view, an end elevational view, and a top plan view, respectively, of an illustrative embodiment of the vehicle 100 according to the present invention. The vehicle 100 comprises a plurality of wheel assemblies 102 articulated with a chassis 104. In the illustrated embodiment, each of the plurality of wheel assemblies 102 is rotationally articulated with the chassis 104, as indicated by arrows 103. Other articulations, however, are possible, such as linear articulations. For instance, FIG. 17A-FIG. 17B depict one particular embodiment of an articulated vehicle 1700 comprising a plurality of wheel assemblies 1702 (only four shown) that are each independently, linearly articulated (as indicated by arrow 1703) with respect to a chassis 1704 by an actuator 1706 (only three shown in FIG. 17A, only two shown in FIG. 17B). FIGS. 17A-17B illustrate only two of a multitude of articulated poses that the vehicle 1700 may take on. While the discussion below particularly relates to the vehicle 100, which employs rotational articulation, the present invention is not so limited. Rather, the scope of the present invention relates to a vehicle utilizing any type of articulation, as the embodiments of FIGS. 1A-1C and FIG. 17 are merely two of many types of articulated vehicles encompassed by the present invention.

In the embodiment illustrated in FIGS. 1A-1C, the wheel assemblies 102, when attached to the chassis 104, implement an articulated suspension system for the vehicle 100. Thus, by way of example and illustration, the articulated suspension system is but one articulable means for rolling the chassis 104 along a path in accordance with the present invention.

Each of the wheel assemblies 102 comprises a link structure or suspension arm, 112, a wheel 116 articulable with respect to the link structure 112, and a hub drive 114 for rotating the wheel 116. The vehicle 100, as illustrated in FIG. 1A-FIG. 1C, includes six wheel assemblies 102. The present invention, however, is not limited to a vehicle (e.g., the vehicle 100) having six wheel assemblies 102. Rather, the scope of the present invention encompasses such a vehicle having any chosen number of wheel assemblies 102, for example, four wheel assemblies 102 or eight wheel assemblies 102.

The vehicle 100, for example, may comprise the same number of wheel assemblies 102 articulated with a first side 106 and articulated with a second side 108 of the chassis 104, as shown in FIG. 1A-FIG. 1C. However, the vehicle 100 may alternatively include a different number of wheel assemblies 102 articulated with the first side 106 than are articulated with the second side 108. Thus, for example, the scope of the present invention encompasses a vehicle (e.g., the vehicle 100) having three wheel assemblies 102 articulated with the first side 106 and four wheel assemblies 102 articulated with the second side 108.

Generally, a vehicle 100, such as the one shown in FIG. 1A-FIG. 1C, comprises:

the chassis 104;

a plurality of suspension arms 112;

a shoulder joint for articulating each of the suspension arms 112 with the chassis 104;

an active damper (e.g., a magnetorheological (“MR”) rotary damper) connecting each of the suspension arms 112 to the chassis 104;

a drive train for propelling the vehicle 100; and

a power system for powering the drive train, control system, and other elements of the vehicle 100.

Each of these components will now be discussed in turn.

### A. The Chassis

The chassis 104 is illustrated in FIG. 1A-FIG. 1C (and others) in a stylized fashion and, thus, corresponds to any chosen type of chassis 104 for the vehicle 100. For example, the chassis 104 may have a configuration capable of carrying cargo or personnel, capable of deploying armaments, adapted for reconnaissance tasks, or capable of assisting dismounted personnel to traverse an obstacle to their progress. Important design considerations include: structural strength; stiffness; survivability; weight; stiffness-to-weight ratio; damage tolerance; repairability; corrosion resistance; modularity; and optimized component packaging and integration.

### B. The Suspension Arms

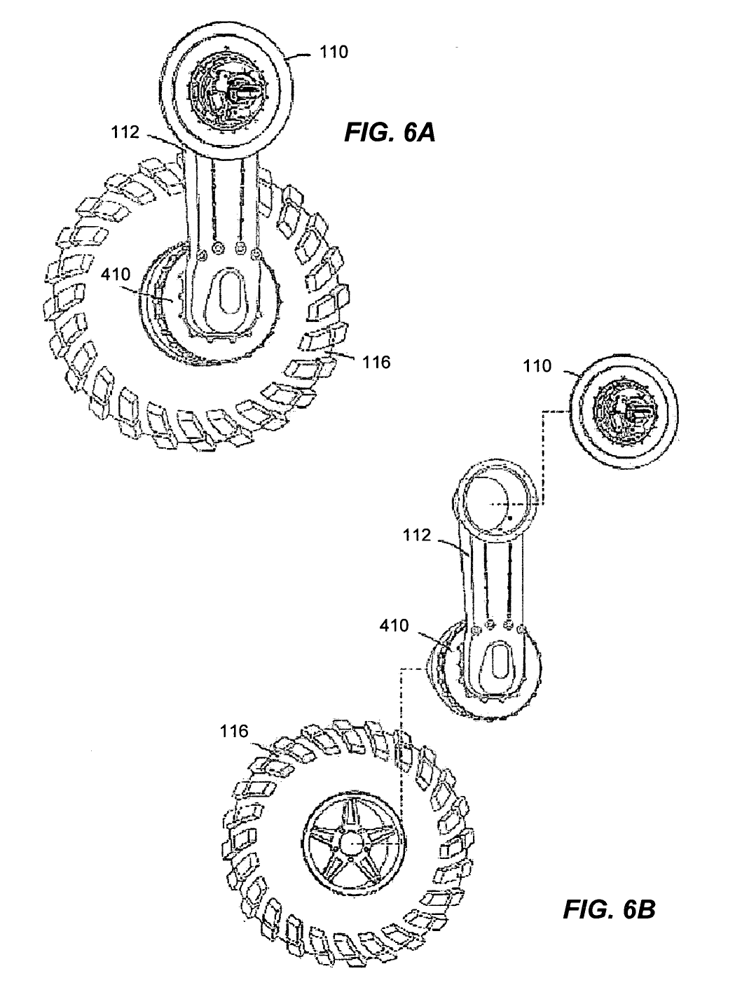

As is best shown in FIG. 6A-FIG. 6B, one embodiment of the suspension arm 112 has a hollow construction that is structurally efficient and provides for mounting of motors, controller, wiring, etc., within the suspension arm 112. The suspension arm 112 is subject to multidirectional bending, shocks and debris impact/wear. The suspension arm 112 is, in the illustrated embodiment, made of ceramic (alumina) fiber reinforced aluminum alloy, i.e., the suspension arm 112 comprises a “metal matrix composite” material. This material provides for high thermal conductivity, high specific stiffness, high specific strength, good abrasion resistance and long fatigue life.

Some embodiments may include ceramic particulate reinforcement in at least selected portions. Alternatively, the suspension arms 112 may comprise aluminum with a carbon fiber laminated overwrap. The suspension arm 112 therefore also provides mechanical protection and heat sinking for various components that may be mounted on or in the suspension arm 112. Note that the length of the suspension arm 112 may be varied depending on the implementation. In alternative embodiments, a double “A-arm” wishbone suspension (not shown) may be used instead of the articulated, trailing suspension arm design of the illustrated embodiment.

### C. The Shoulder Joints

Still referring to FIG. 1A-FIG. 1C, each of the wheel assemblies 102 is independently articulated with the chassis 104 by one of a plurality of driven shoulder joints 110. When a particular shoulder joint 110 is articulated, the wheel assembly 102 coupled therewith is articulated with respect to the chassis 104. In this particular embodiment, the articulation of each shoulder joint comprises in-plane rotation. As discussed above, however, other articulations are possible and are within the scope of the present invention. Each of the shoulder joints 110 may be driven by independent drives (i.e., not mechanically linked to each other) or two or more of the shoulder joints 110 may be driven by components of a power transmission system (e.g., a geartrain with clutched power take-offs) capable of operating each of the shoulder joints 110 independently. Each of the shoulder joints 110 may be driven by the same type of drive or they may be driven by different types of drives.

Each of the wheel assemblies 102 may be independently articulated, via its shoulder joint 110, to any desired rotational position with respect to the chassis 104 at a chosen speed. For example, in the illustrated embodiment, each of the wheel assemblies 102 may be moved from a starting rotational position (e.g., a “zero” or “home” rotational position) to a rotational position of 45 degrees clockwise, to a rotational position of 350 degrees counterclockwise, or to any other desired rotational position. Each of the wheel assemblies 102 of the illustrated embodiment may be rotated via its shoulder joint 110 more than a full revolution (i.e., more than 360 degrees).

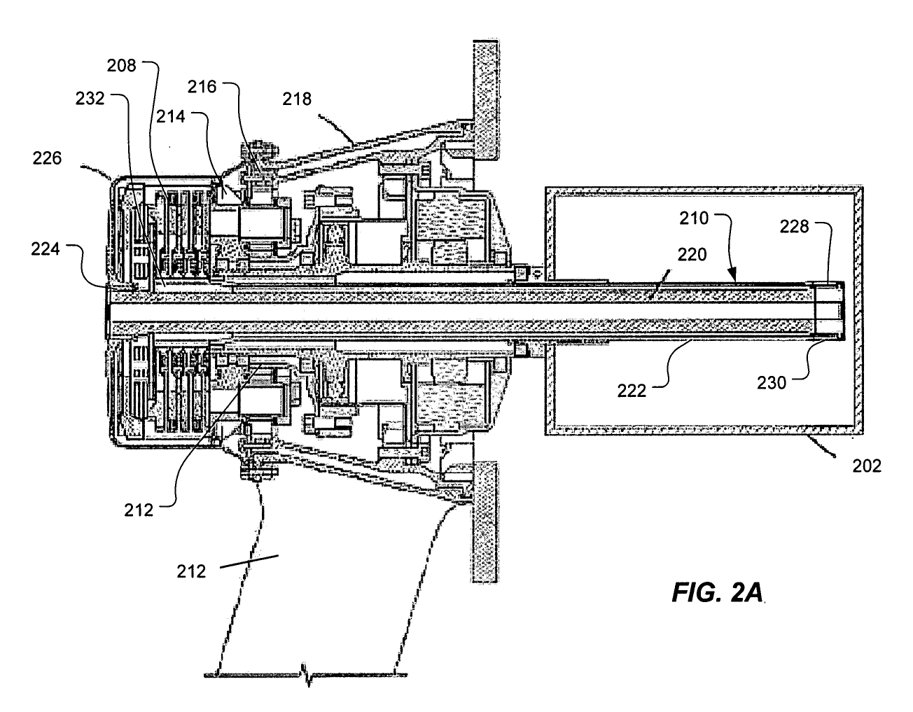

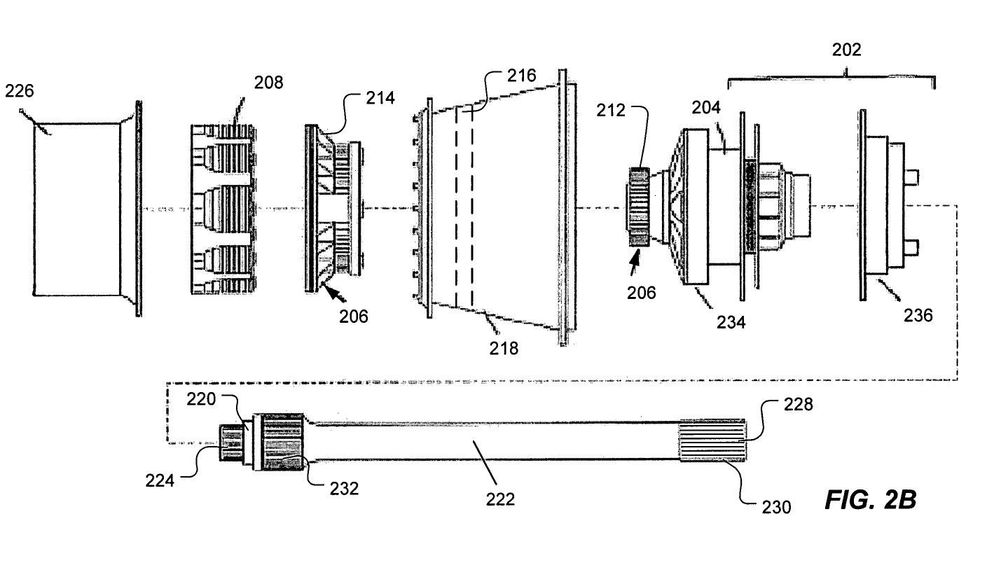

FIG. 2A-FIG. 2C depict one particular illustrative embodiment of the shoulder joint 110. The shoulder joint 110 comprises, in the embodiment illustrated in FIG. 2A-FIG. 2C, a drive 202, a harmonic drive 204, a planetary gear set 206, a slip clutch 208, and a torsion bar assembly 210 connected in series between the chassis 104 and a link structure 112 (each shown in FIG. 1A-FIG. 1C). The planetary gear set 206 includes a sun gear 212 that engages a planetary gear 214 that, in turn, engages a ring gear 216 on the interior of a housing 218. The torsion bar assembly 210 includes an inner torsion bar 220 and an outer torsion bar 222. The inner torsion bar 220 includes, on one end thereof, a plurality of splines 224 that engage an end bell 226. The inner torsion bar 220 is nested within the outer torsion bar 222 and includes, on the other end, a plurality of splines 228 that engage an interior of a cup 230 of the outer torsion bar 222. The outer torsion bar 222 also includes a plurality of splines 232 that engages the slip clutch 208.

The shoulder joint 110 also includes a housing 218 to which the suspension arm 112 is attached. Note that, in the illustrated embodiment, the suspension arm 112 is fabricated integral to the housing 218, i.e., the housing 218 and the suspension arm 112 structurally form a single part. A plurality of bearings (not shown) are disposed within the housing 218. The bearings interact with the planetary gear set 206 to rotate the housing 218 and, hence, the suspension arm 112. The shoulder joint 110 is capped in the illustrated embodiment by the end bell 226 to transmit torque between the torsion bar assembly 210 and the suspension arm 112, as well as to help protect the shoulder joint 110 from damage and debris.

The drive 202 is, in the illustrated embodiment, an electric motor including a rotor 234 and a stator 236. The drive 202 can be co-aligned along the same axis of the shoulder joint 110, as depicted in the illustrated embodiment. Alternatively, the drive 202 can be offset (not shown) and connected to the axis of actuation through a transmission, e.g., a chain-driven transmission. The drive 202 does not have to be electric, and can be a hydraulic, pneumatic, or a hybrid motor system. The drive 202 may comprise any type of drive known to the art, for example, a direct drive motor, a servo motor, a motor-driven gear set, an engine-driven gear set, a rotary actuator, or the like. The drives 202 may be mechanically independent drives (i.e., not mechanically linked to each other) or may be components of a power transmission system (e.g., a gear train with clutched power take-offs) capable of operating each of the drives 202 independently.

The harmonic drive 204 and the planetary gear set 206 implement a mechanical transmission. Some embodiments may include alternative mechanical transmissions and may also include a spur gear train, a traction drive, etc., in implementing a mechanical transmission. Mechanical transmissions have three primary applications in machine design: speed reduction, transferring power from one location to another, and converting motion from prismatic to rotary or vice versa. The shoulder joint 110 employs the mechanical transmission for speed reduction, which proportionally increases torque to rotate the wheel assembly 102. For most moving parts, bearings are used to reduce friction and typically are designed in pairs to protect against both radial and thrust loading on the actuator. Since the bearings transfer loads, the structure or housing of the shoulder actuator should be designed adequately to preclude structural failures and deflections. The harmonic drive 204 provides a first speed reduction and the planetary gear set 206 provides a second speed reduction.

The drive 202 and the transmission (i.e., the harmonic drive 204 and planetary gear set 206) may be considered the heart of the actuator for the shoulder joint 110. The remaining components facilitate the operation of the drive 202 and the transmission and may be omitted in various alternative embodiments (not shown). A clutch assembly (i.e. the slip clutch 208) may be integrated such that the linked wheel assembly 102 may be disengaged (not powered or controlled) where positioning is passive based only on gravity effects. The slip clutch 208 also limits the torque through the drive system and is capable of dissipating energy to prevent damage. Similarly, a torsion assembly (i.e. the torsion bar assembly 210) may be used to control the twist properties of the shoulder joint 110 by actively engaging different effective torsion bar lengths. Thus, some embodiments may include the slip clutch 208 and/or the torsion bar assembly 210, whereas others may omit them.

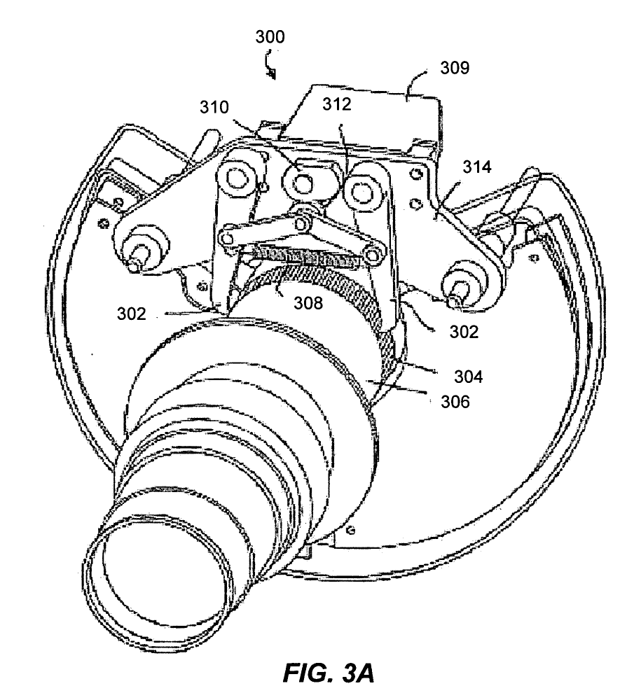

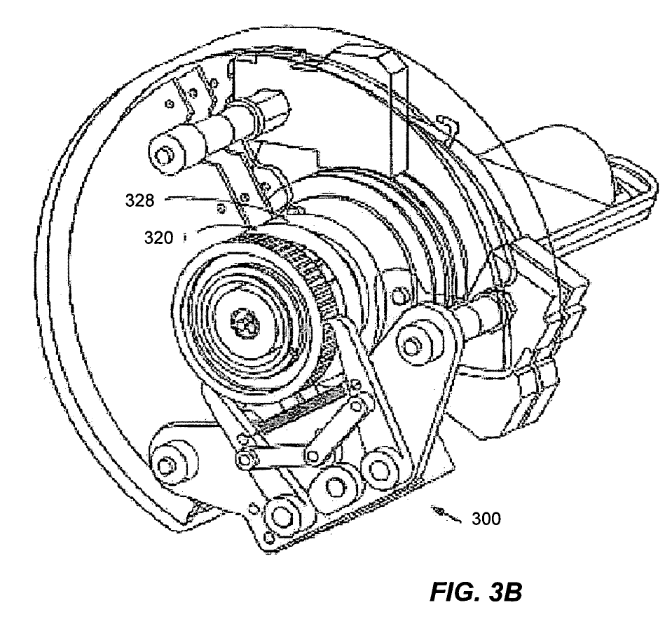

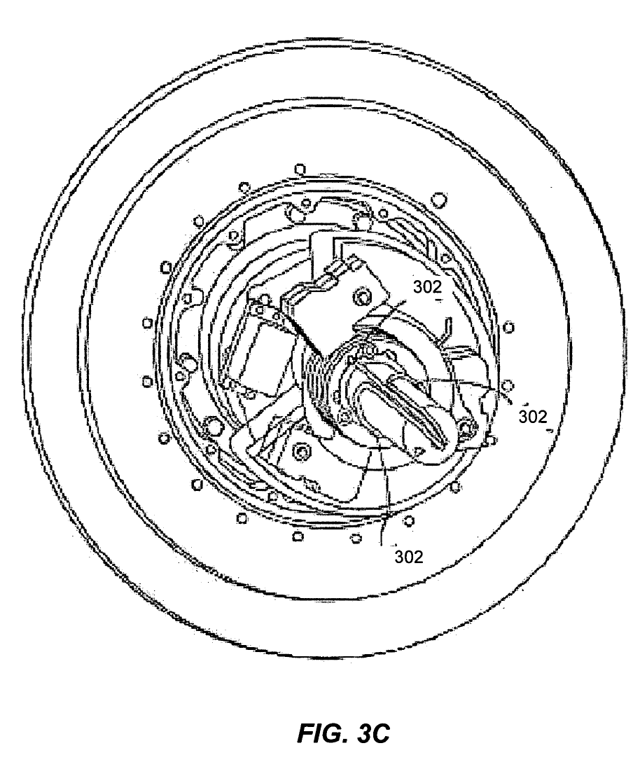

As is shown in FIG. 3A-FIG. 3B, in one embodiment, a small spring-applied, electrically released locking mechanism 300 prevents rotation of the drive 202 so that power is not required when the vehicle 100 is static. The locking mechanism 300 is a fail-safe/power-off device, which is spring actuated or actuated by using another motor to incrementally increase the friction between two surfaces based on pressure (i.e., a clamping effect). Thus, the locking mechanism 300 is able to lock the joint at a prescribed position.

More particularly, the locking mechanism 300 of the illustrated embodiment includes a pair of pawls 302 that interact with a toothed lock ring 304 on the motor shaft 306 of the drive 202. A spring 308, or some other biasing means, biases the pawls 302 to close on the lock ring 304 when the cam 310 is positioned by the servo-motor 309 to allow for movement of the driver 312 and linkage. To unlock the locking mechanism 300, the servo-motor 309 actuates the cam 310 to operate against the driver 312 and open the pawls 302 away from the lock ring 304. Note that the pawls 302, the servo-motor 309, cam 310, and driver 312 are all mounted to a mounting plate 314 that is affixed to the chassis 104 (shown in FIG. 1). When the locking mechanism 300 is engaged, no power is required. However, in some alternative embodiments, a spring-applied brake may be used to facilitate locking the actuator shaft 306. In these embodiments, the locking mechanism 300 will still lock the shoulder joint 110 on power failure, but will consume power when unlocked, as long as power is available.

Returning to FIG. 2A-FIG. 2C, the drive 202, sensors (discussed below), control system (discussed below), slip clutch 208, and locking mechanism 300 (shown in FIG. 3A-FIG. 3C) all require power. Power is provided by the vehicle 100 (shown in FIG. 1) to each shoulder joint 110 and moreover, some power is passed through from the vehicle chassis 104 through the shoulder joint 110 and to the hub drive 114 to drive the wheel 116. In addition to power, data signals follow the same path. To pass power and data signals over the rotary shoulder joints 110, a plurality of slip rings 332, shown in FIG. 3C, are used. The supply of power should be isolated from data due to noise issues, and the illustrated embodiment employs separate slip rings to transmit power and data. Note that conductors (not shown) are attached to each side of the slip rings 332, with each side rotatably in contact with each other to maintain continuity.

### D. The Active Dampers

Vibrations or other undesirable motions induced into the vehicle 100 by rough terrain over which the vehicle 100 travels may be dampened by the mechanical compliance of the wheels 116. In other words, the wheels 116 deform to absorb the shock forces resulting from traveling over rough terrain. Such shock forces may be absorbed by optional shock absorbers, spring elements, and/or dampers, such as those known to the art.

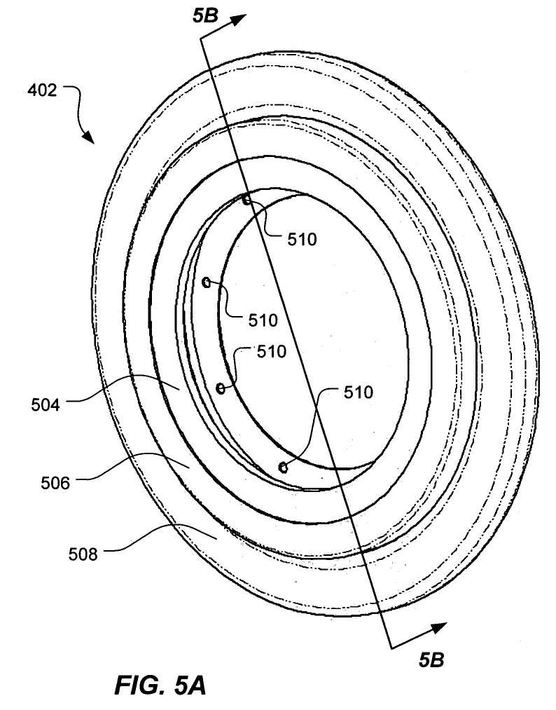

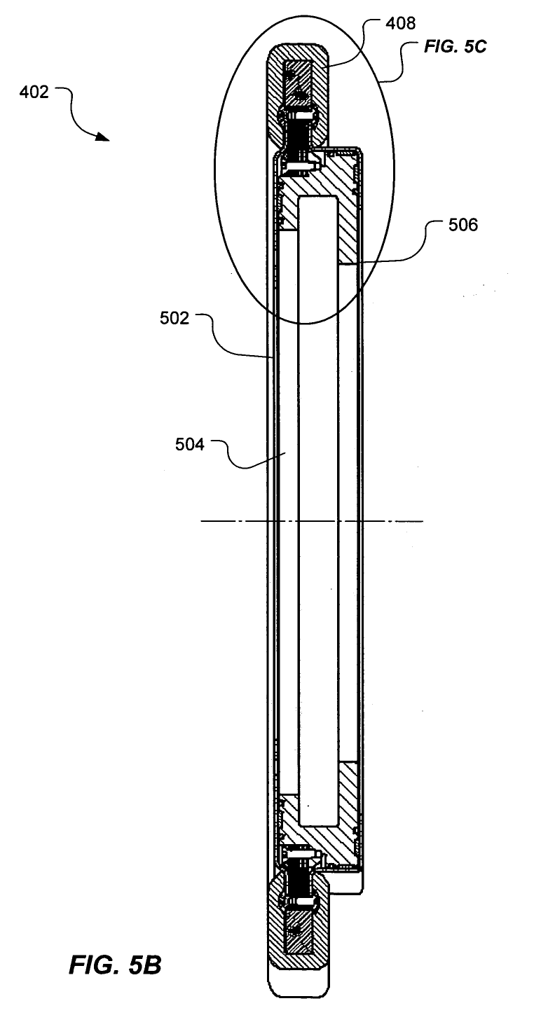

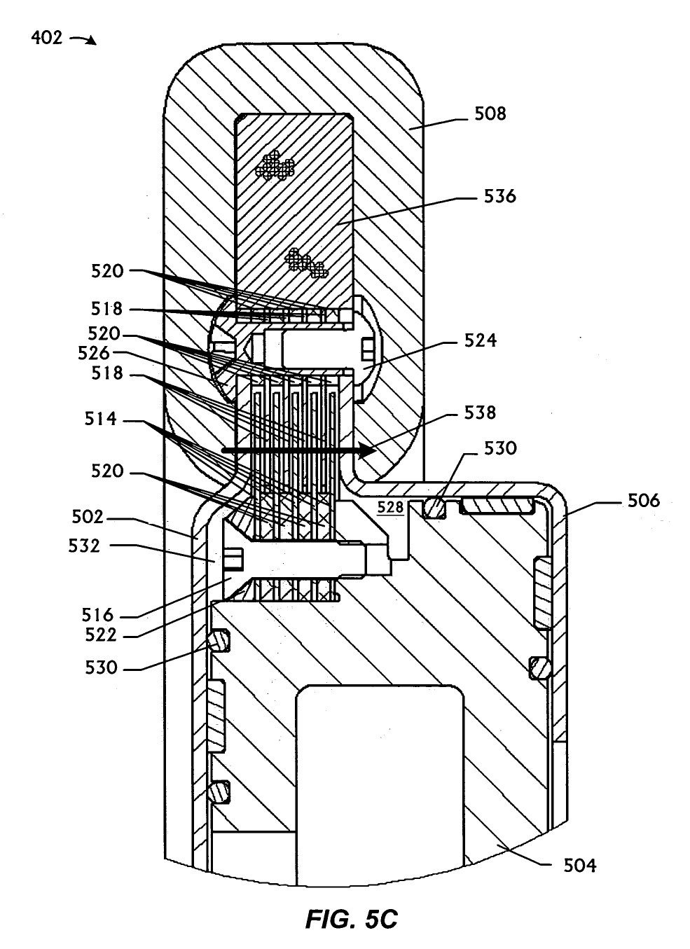

Other options include the integration of an active damper to add additional dampening suspension characteristics. In the embodiment illustrated in FIG. 4, the vehicle 100 comprises a controllable, magnetorheological (MR) fluid based, rotary damper 402, which is merely one type of active damper, connecting the suspension arm 112 to the chassis 104, mounted in parallel with the shoulder joint 110. The rotary MR damper 402, first shown in FIG. 4 but best shown in FIG. 5A-FIG. 5C, at each suspension arm 112 provides actively variable damping torque controlled by a central computer (discussed below). The rotary MR damper 402 acts as a Coulomb damper, rather than a dashpot. This control allows for optimized vehicle dynamics, improved traction, articulation, impact absorption and sensor stabilization. The system improves obstacle negotiation by enabling the shoulder joints 110 to be selectively locked, improving suspension arm 112 position control. Damping is controllable via a magnetically sensitive fluid. The fluid shear stress is a function of the magnetic flux density. The flux is generated by an integrated electromagnet that is capable of varying the resultant damping torque in real time.

The MR rotary damper 402 controls the applied torque on the shoulder joint 110 during all of the vehicle operational modes. It provides the muscle to the vehicle 100 for absorbing impacts, damping the suspension and accurately controlling the position of the joint. The MR rotary damper 402 increases traction and decreases the transmission of vertical accelerations into the chassis 104. The MR damper 402's ability to change damping force in real-time via software control maintains suspension performance over all operating conditions, such as changing wheel loads, varying wheel positions, and varying the vehicle 100 center of gravity.

Still referring to FIG. 5A-FIG. 5C, the rotary damper 402 includes an inner housing 502, a rotor 504, an outer housing 506, and a segmented flux housing 508. The inner housing 502, outer housing 506, and segmented flux housing 508 are fabricated from a “soft magnetic” material (i.e., a material with magnetic permeability much larger than that of free space), e.g., mild steel. The rotor 504 is made from a “nonmagnetic” material (i.e., a material with magnetic permeability close to that of free space), e.g., aluminum. In one embodiment, the segmented flux housing 508 is fabricated from a high performance magnetic core laminating material commercially available under the trademark HIPERCO 50® from:

Carpenter Technology Corporation
P.O. Box 14662
Reading, PA 19612-4662
U.S.A.

However, other suitable, commercially available soft magnetic materials, such as mild steel, may be used.

The rotary damper 402 is affixed to, in this particular embodiment, a chassis 104 by fasteners (not shown) through a plurality of mounting holes 510 of the inner housing 502. The rotor 504 is made to rotate with the pivoting element (not shown) with the use of splines or drive dogs (also not shown). Note that the rotary damper 402 may be affixed to the suspension arm 112 and the chassis 104 in any suitable manner known to the art. The rotary damper 402 damps the rotary movement of the arm pivot relative to the chassis 104 in a manner more fully explained below.

Referring to FIG. 5C, pluralities of rotor plates 514, separated by magnetic insulators 520, are affixed to the rotor 504 by, in this particular embodiment, a fastener 516 screwed into the rotor plate support 522 of the rotor 504. A plurality of housing plates 518, also separated by magnetic insulators 520, are affixed to an assembly of the inner housing 502 and outer housing 506, in this embodiment, by a fastener 524 in a barrel nut 526. Note that the assembled rotor plates 514 and the assembled housing plates 518 are interleaved with each other. The number of rotor plates 514 and housing plates 518 is not material to the practice of the invention.

The rotor plates 514 and the housing plates 518 are fabricated from a soft magnetic material having a high magnetic permeability, e.g., mild steel. The magnetic insulators 520, the fasteners 516, 524, and the barrel nut 526 are fabricated from nonmagnetic materials, e.g., aluminum or annealed austenitic stainless steel. The nonmagnetic fasteners can be either threaded or permanent, e.g., solid rivets. The rotor plates 514 and the housing plates 518 are, in this particular embodiment, disc-shaped. However, other geometries may be used in alternative embodiments and the invention does not require that the rotor plates 514 and the housing plates 518 have the same geometry.

Still referring to FIG. 5C, the assembled inner housing 502, rotor 504, and outer housing 506 define a chamber 528. A plurality of O-rings 530 provide a fluid seal for the chamber 528 against the rotation of the rotor 504 relative to the assembled inner housing 502 and outer housing 506. An MR fluid 532 is contained in the chamber 528 and resides in the interleave of the rotor plates 514 and the housing plates 518 previously described above. In one particular embodiment, the MR fluid 532 is MRF132AD, commercially available from:

Lord Corporation
Materials Division
406 Gregson Drive
P.O. Box 8012
Cary, NC 27512-8012
U.S.A.

However, other commercially available MR fluids may also be used.

The segmented flux housing 508 contains, in the illustrated embodiment, a coil 536, the segmented flux housing 508 and coil 536 together comprising an electromagnet. The coil 536, when powered, generates a magnetic flux in a direction transverse to the orientation of the rotor plates 514 and the housing plates 518, as represented by the arrow 538. Alternatively, a permanent magnetic 540 could be incorporated into the flux housing 508 to bias the magnetic flux 538. The coil 536 drives the magnetic flux through the MR fluid 532 and across the faces of the rotor plates 514 and the housing plates 518. The sign of the magnetic flux is not material to the practice of the invention.

The magnetic flux 538 aligns the magnetic particles (not shown) suspended in the MR fluid 532 in the direction of the magnetic flux 538. This magnetic alignment of the fluid particles increases the shear strength of the MR fluid 532, which resists motion between the rotor plates 514 and the housing plates 518. When the magnetic flux is removed, the suspended magnetic particles return to their unaligned orientation, thereby decreasing or removing the concomitant force retarding the movement of the rotor plates 514. Note that it will generally be desirable to ensure a full supply of the MR fluid 532. Some embodiments may therefore include some mechanism for accomplishing this. For instance, some embodiments may include a small fluid reservoir to hold an extra supply of the MR fluid 532 to compensate for leakage and a compressible medium for expansion of the MR fluid 532.

Returning to the illustrated embodiment, the control system commands an electrical current to be supplied to the coil 536. This electric current then creates the magnetic flux 538 and the rotary damper 402 resists relative motion between the housings 502, 506 and the rotor 504. Depending on the geometry of the rotary damper 402 and the materials of its construction, there is a relationship between the electric current, the relative angular velocity between the housings 502, 506 and the rotor 504, and the resistive torque created by the rotary damper 402. In general this resistive torque created by the rotary damper 402 increases with the relative angular motion between the housings 502, 506 and the rotor 504 and larger magnetic flux density through the fluid 532 as generated by the coil electric current.

Unfortunately, the MR rotary damper 402 tends to have a high inductance. This problem can be mitigated with the use of high control voltages which allow for high rates of change in damper current (di/dt), although this may lead to increased power demands and higher levels of inefficiency depending on the design and the software control driving the rotary damper 402. Another technique, which may improve the bandwidth and efficiency of the MR rotary damper 402, uses multiple coil windings. One such system could use two coil windings; one high inductance, slow coil with a high number of turns of small diameter wire and a second low inductance, fast coil with a low number of turns of larger diameter wire. The slow coil could be used to bias the rotary damper 402 while the fast coil could be used to control around this bias. However, the two coil windings may be highly coupled due to the mutual inductance between them in some implementations, which would be undesirable.

The MR rotary damper 402 is but one means for actively damping the articulated suspension. Other devices may be used to actively damp the articulated suspension.

### E. The Drive Train

Referring again to FIG. 1A-FIG. 1C, each of the wheels 116 is mounted to and rotates with respect to its link structure 112 via its hub drive 114, which is capable of selectively rotating the wheel 116 (as indicated by arrows 117) at a chosen speed. Each of the drives 114 may comprise any type of drive known to the art, for example, a direct-drive motor, a servo motor, a motor-driven gear train, an engine-driven gear train, a rotary actuator, or the like. Further, each of the drives 114 may be of the same type or they may comprise different types of drives. By actuating some or all of the drives 114 at the same or different speeds, the vehicle 100 may be propelled across a surface 118 along a chosen path.

In the particular embodiment illustrated in FIG. 4, each of the wheels 116 further comprises a tire 410 mounted to a rim 412. The tire 410 may comprise any suitable tire known to the art, such as a pneumatic tire, a semi-pneumatic tire, a solid tire, or the like.

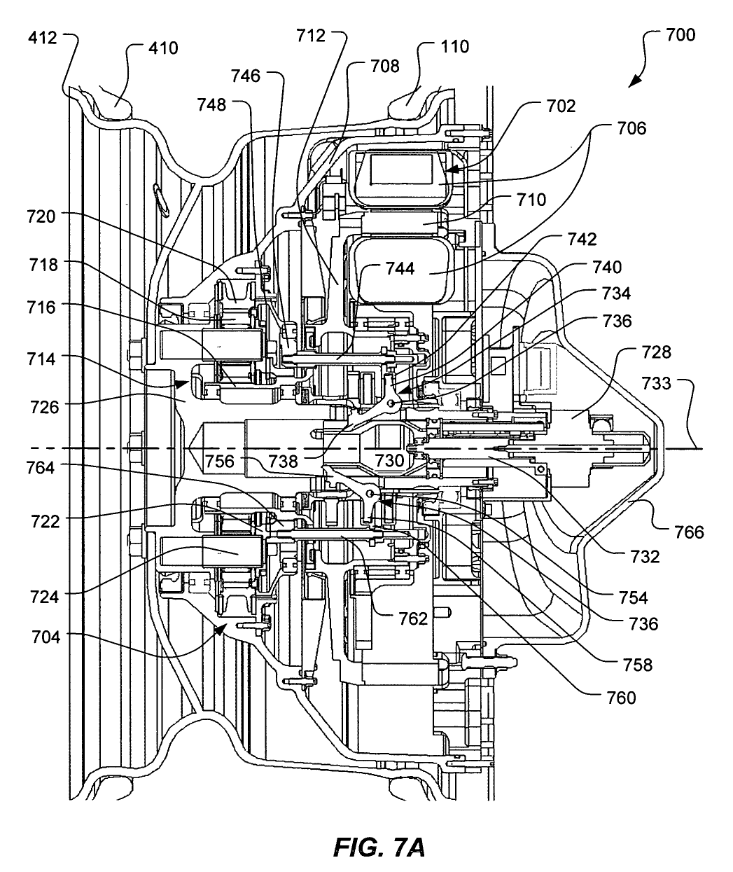

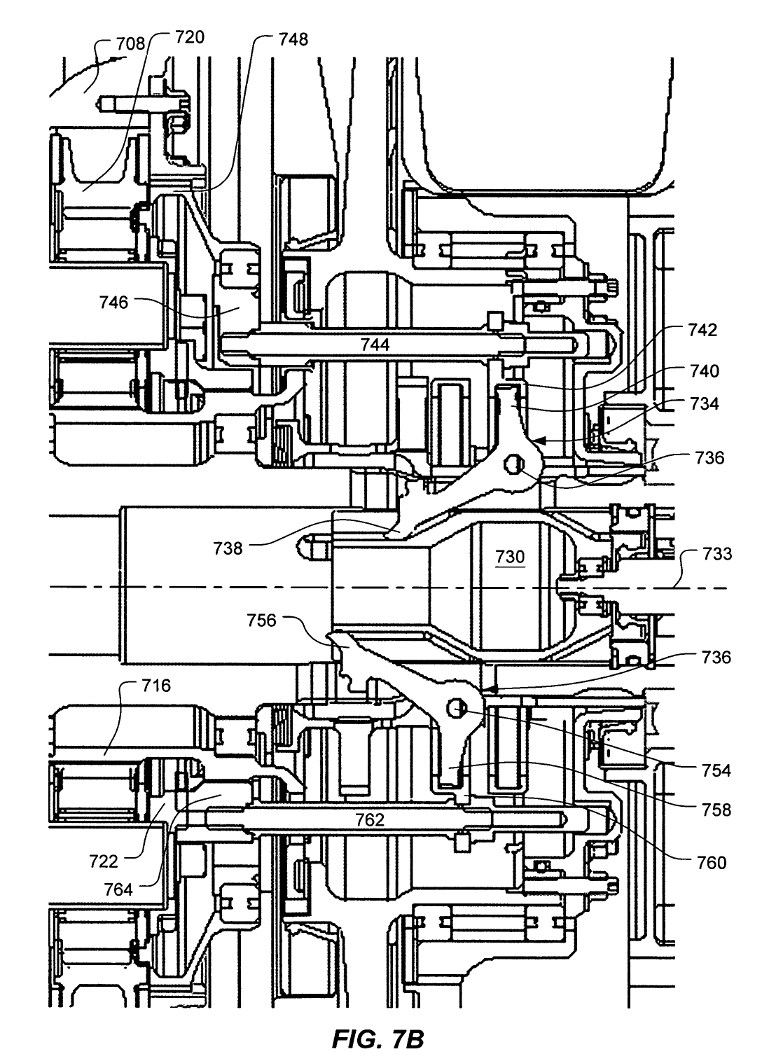

FIGS. 7A and 8-10 are cross-sectional, side views depicting the illustrated embodiment of the hub drive 114 in park mode, high speed mode, neutral mode, and low speed mode, respectively. The hub drive 114 includes a motor 702 and a transmission 704 having an input attached to the motor 702 and an output attached to the rim 412 of the wheel 108, each being disposed within the wheel 108 and, in the illustrated embodiment, being disposed within the rim 412. The motor 702 comprises a stator 706, attached to the vehicle 100 via a hub casing 708, and a rotor 710, attached to a rotor hub 712. In various embodiments, the motor 702 may comprise a variable reluctance motor, a DC brushless motor, a permanent magnet motor, or the like.

Still referring to FIGS. 7A and 8-10, the transmission 704 comprises an epicyclic gear train 714, which further includes a sun gear 716, a plurality of planetary gears 718 engaged with the sun gear 716, and a ring gear 720 engaged with the planetary gears 718. Each of the planetary gears 718 is held in position by a spindle 726 and a carrier cover plate 722 via a shaft 724. The spindle 726 and the carrier cover plate 722 implements a planetary gear carrier. The rotor hub 712, which is attached to the rotor 710 as described above, is coupled with the sun gear 716. Thus, as the motor 702 operates, the rotor 710 is caused to rotate with respect to the stator 706 and, correspondingly, rotates the sun gear 716. In the illustrated embodiment, the planetary gear carrier 722 is attached to the rim 412 by the spindle 726 and, thus, power from the motor 702 is transmitted from the motor 702, through the epicyclic gear train 714, to the rim 412.

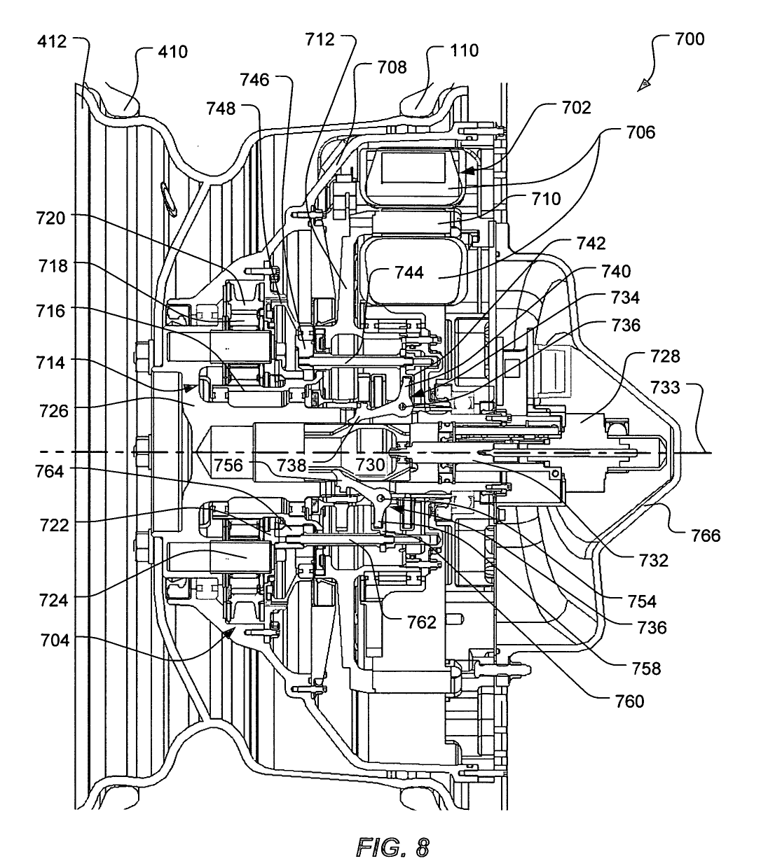

Various outputs or operating modes may be accomplished by placing the epicyclic gear train 714 in different operational configurations. For example, the hub drive 114 may be placed in park mode, shown better in FIGS. 7A-8B, by locking the planetary gear carrier 722 to the sun gear 716 and by locking the ring gear 720 to the hub casing 708, as will be discussed further below, to prevent the epicyclic gear train 714 from transmitting power therethrough. Further, the hub drive 114 may be placed in high speed mode, illustrated better in FIG. 8, by locking the planetary gear carrier 722 to the sun gear 716 and by allowing the ring gear 720 to rotate freely, causing the spindle 726 to rotate at the same speed as the rotor 710.

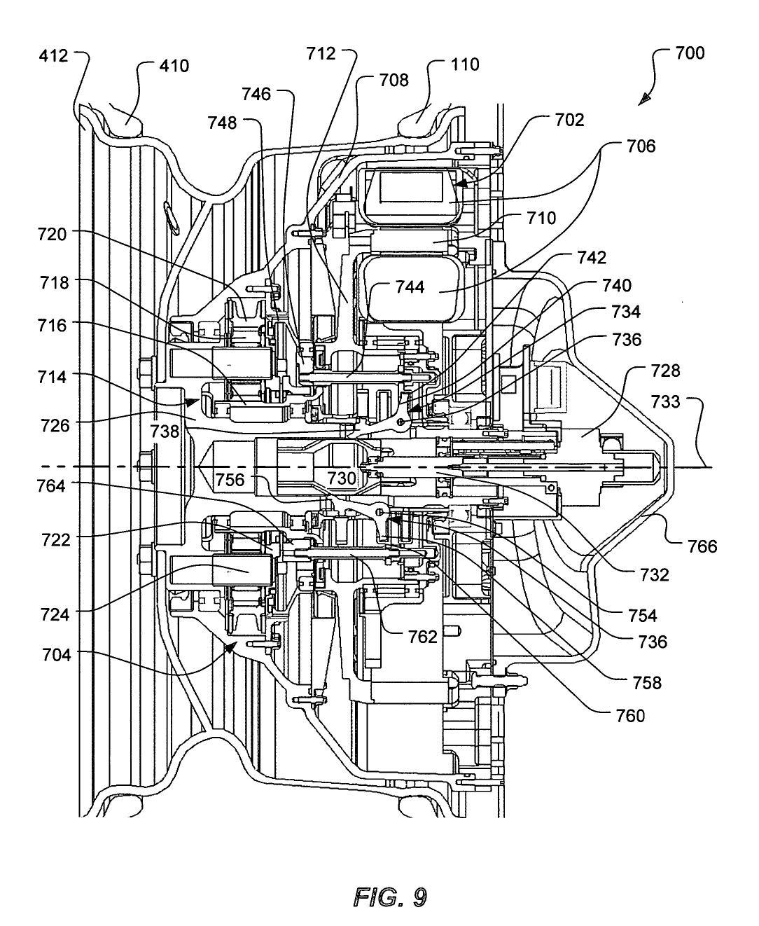

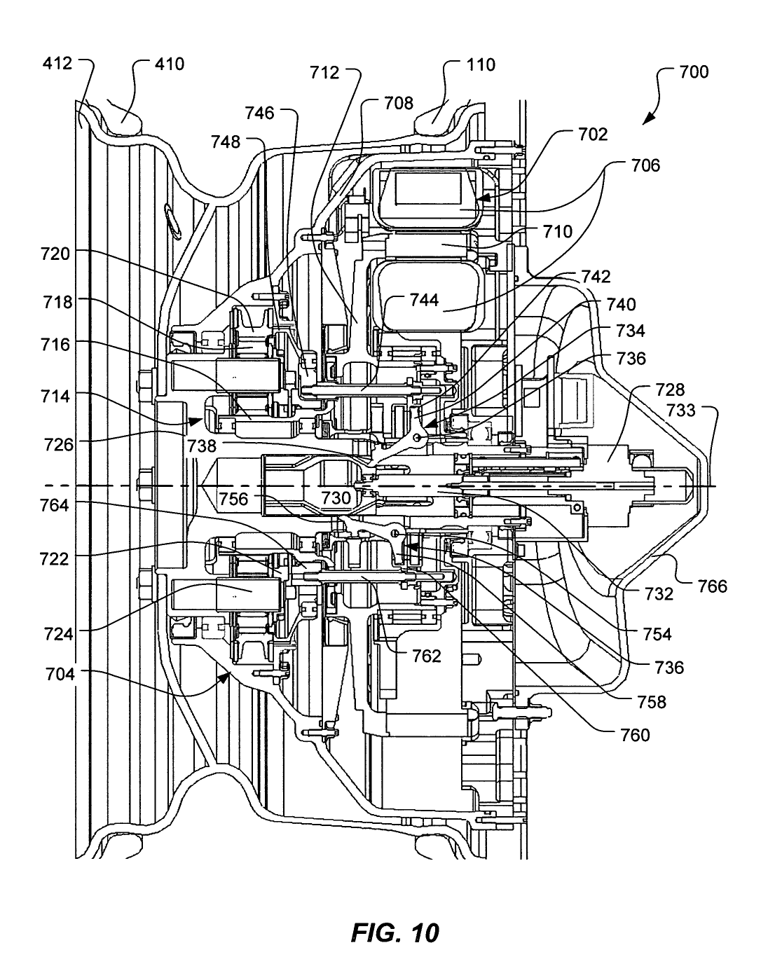

Further, to place the hub drive 114 in neutral mode, illustrated better in FIG. 9, the spindle 726 is allowed to rotate freely by causing the planetary gear carrier 722 to rotate independently of the sun gear 716 and by causing the ring gear 720 to rotate freely. The hub drive 114 may be placed in low speed mode, illustrated better in FIG. 10, by reducing the rotational speed of the spindle 726 with respect to the rotor 710. In this configuration, the planetary gear carrier 722 is allowed to rotate independently of the sun gear 716 and the ring gear 720 is locked to the hub casing 708, which causes the sun gear 716 to rotate the planetary gears 718 against the fixed ring gear 720, driving the planetary gear carrier 722 and the spindle at a lower speed than the sun gear 716.

To effect these configurations, the transmission 704 illustrated in FIGS. 7A-11 includes a shift motor 728 that linearly actuates a shift drum 730 via a shift pin 732 along an axis 733. As the shift drum 730 is moved to various positions by the shift motor 728, the epicyclic gear train 714 is shifted into the various operating modes by pivoting a first shift lever 734 and/or a second shift lever 736 via the shift drum 730. Referring now to FIG. 7B, which provides an enlarged view of a portion of the transmission 704 of FIG. 7A, the first shift lever 734 is pivotably mounted by a pin 736, such that a first leg 738 of the first shift lever 734 is biased against the shift drum 730. A second leg 740 of the first shift lever 734 extends into a first shift ring 742, which is attached to a first shift spacer 744. The first shift spacer 744 is attached to a ring gear dog hub 746, which is attached to a ring gear dog ring 748.

The ring gear dog ring 748 may be selectively contacted to the ring gear 720 to lock the ring gear 720 to the hub casing 708. For example, when the first shift lever 734 is pivoted by the shift drum 730 such that the first leg 738 thereof moves away from the axis of motion 733 of the shift drum 730, the ring gear dog ring 748 is disengaged from the ring gear 720, as shown in FIGS. 8 and 9. Conversely, when the first shift lever 734 is pivoted by the shift drum 730 such that the first leg 738 thereof moves toward the axis of motion 733 of the shift drum 730, the ring gear dog ring 748 is engaged with the ring gear 720, as depicted in FIGS. 7A, 7B, and 10.

Similarly, the transmission 704 further comprises a second shift lever 752 that is pivotably mounted by a pin 754, such that a first leg 756 of the second shift lever 752 is biased against the shift drum 730. A second leg 758 of the second shift lever 752 extends into a second shift ring 760, which is attached to a second shift spacer 762. The second shift spacer 762 is attached to a planetary carrier dog ring 764. The planetary carrier dog ring 764 may be selectively contacted to the planetary carrier 722 to lock the planetary gear carrier 722 to the sun gear 716. For example, when the second shift lever 752 is pivoted by the shift drum 730 such that the first leg 756 thereof moves away from the axis of motion 733 of the shift drum 730, the planetary carrier dog ring 764 is disengaged from the planetary gear carrier 722, as shown in FIGS. 8 and 9. Conversely, when the second shift lever 752 is pivoted by the shift drum 730 such that the first leg 756 moves toward the axis of motion 733 of the shift drum 730, the planetary carrier dog ring 764 is engaged with the planetary gear carrier 722, as shown in FIGS. 7A, 7B, and 8. A cover 766 is employed in one embodiment to protect the hub drive 714 from debris.

FIGS. 7A-7B illustrate the hub drive 114 in its park configuration. In the illustrated embodiment, the shift drum 730 is in its far outboard position. In this configuration, the first shift lever 734 is pivoted such that the planetary carrier dog ring 764 is engaged with the planetary gear carrier 732, thus locking the planetary gear carrier 732 to the sun gear 716. Further, the second shift lever 736 is pivoted such that the ring gear dog ring 748 is engaged with the ring gear 720, thus locking the ring gear 720 to the hub casing 708. As a result, the rotor 710 and the stator 706 of the motor 702 are inhibited from moving relative to each other and the spindle 726 is inhibited from rotating.

FIG. 8 depicts the hub drive 114 in its high speed configuration. In the illustrated embodiment, the shift drum 730 is positioned inboard of its park position, shown in FIG. 7A. In this configuration, the first shift lever 734 is pivoted such that the planetary carrier dog ring 764 is engaged with the planetary gear carrier 732, thus locking the planetary gear carrier 732 to the sun gear 716. Further, the second shift lever 736 is pivoted such that the ring gear dog ring 748 is disengaged from the ring gear 720, thus allowing the ring gear 720 to rotate freely. As a result, the spindle 726 is locked to the ring gear 720, creating a direct drive. In other words, the spindle 726 and the rim 412 rotates at the same speed as the motor 702.

FIG. 9 depicts the hub drive 114 in its neutral configuration. In the illustrated embodiment, the shift drum 730 is positioned inboard of its high speed position, shown in FIG. 8. In this configuration, the first shift lever 734 is pivoted such that the planetary carrier dog ring 764 is disengaged from the planetary gear carrier 732, allowing the planetary gear carrier 732 to rotate independently of the sun gear 716. Further, the second shift lever 736 is pivoted such that the ring gear dog ring 748 is disengaged from the ring gear 720, thus allowing the ring gear 720 to rotate freely. As a result, the spindle 726 may rotate independently of any rotation by the motor 702.

FIG. 10 shows the hub drive 114 in its low speed configuration. In the illustrated embodiment, the shift drum 730 is in its far inboard position. In this configuration, the first shift lever 734 is pivoted such that the planetary carrier dog ring 764 is disengaged from the planetary gear carrier 732, thus allowing the planetary gear carrier 732 to rotate independently of the sun gear 716. Further, the second shift lever 736 is pivoted such that the ring gear dog ring 748 is engaged with the ring gear 720, thus locking the ring gear 720 to the hub casing 708. As a result, the sun gear 716 rotates the planetary gears 718 against the fixed ring gear 720, thus driving the planetary gear carrier 732 and the spindle 726 at a lower speed than the motor 702.

While the shift drum 730 is described above as being in a particular inboard/outboard position corresponding to a particular operational mode, the present invention is not so limited. Rather, the scope of the present invention encompasses various designs of the hub drive 114 in which the shift drum 730 is moved to positions different than those described above to achieve the various operational modes thereof. For example, one embodiment of the hub drive 114 may be configured such that the shift drum 730 operates obversely to the operation shown in FIGS. 7A-10. In such an embodiment, the shift drum 730 may be moved from a far inboard position through intermediate positions to a far outboard position to shift the hub drive 114 from the park mode, the high speed mode, the neutral mode, to the low speed mode. Thus, the particular embodiments of the hub drive 114 disclosed above may be altered or modified, and all such variations are considered within the scope of the present invention.

The hub drive 114 is capable of rotating the wheel 108 (each shown in FIG. 1) in either direction. The rotational direction of the transmission 104 may be changed by changing the rotational direction of the motor 102. The rotational direction of the motor 102 may be changed by techniques known to the art depending upon the type of motor used.

Changing the rotational direction of the motor 102 and, thus, the rotational direction of the hub drive 101, may also be used to brake the hub drive 101 by using the motor 102 as a generator to develop negative “braking” torque. For example, if the hub drive 101 is rotating in a first direction and the motor 102 is switched such that it is urged to rotate in a second direction, the motor 102 will be “backdriven” to brake the hub drive 101.

Thus, by combining the shifting capability of the transmission 704 and the capability of the motor 702 to rotate in both directions, the hub drive 114 is capable of rotating the wheel 108 in either direction and in the low speed mode (illustrated in FIG. 4) or the high speed mode (illustrated in FIG. 2). Further, the hub drive 114 is capable of braking while rotating in either direction in the low speed mode or the high speed mode. Further, by placing the hub drive 114 in the park mode, the hub drive 114 is inhibited from rotating and, thus, no additional “parking brake” is required. Yet further, by placing the hub drive 114 in the neutral mode, the wheel 108 may rotate freely, irrespective of the rotation of the motor 702.

### F. The Power System

In one embodiment, electrical power is provided to the motors 702 (and to other electrical equipment of the vehicle 100) by a series hybrid power plant comprising a commercial, off-the-shelf-based single cylinder air-cooled, direct injection diesel engine (not shown) coupled with a commercial, off-the-shelf-based generator (not shown) disposed in the chassis 104 (shown in FIG. 1). The power plant is used in conjunction with at least one string of electrical energy storage devices (not shown), such as lead-acid or lithium-ion batteries, also disposed in the chassis 104, in a series-hybrid configured power train with sufficient buffering and storage in the power and energy management systems. The present invention, however, is not limited to use with the above-described power plant. Rather, any suitable electrical power source may be used to supply power to the motors 702 and the other electrical equipment.

### II. TRACTION CONTROL METHODOLOGY

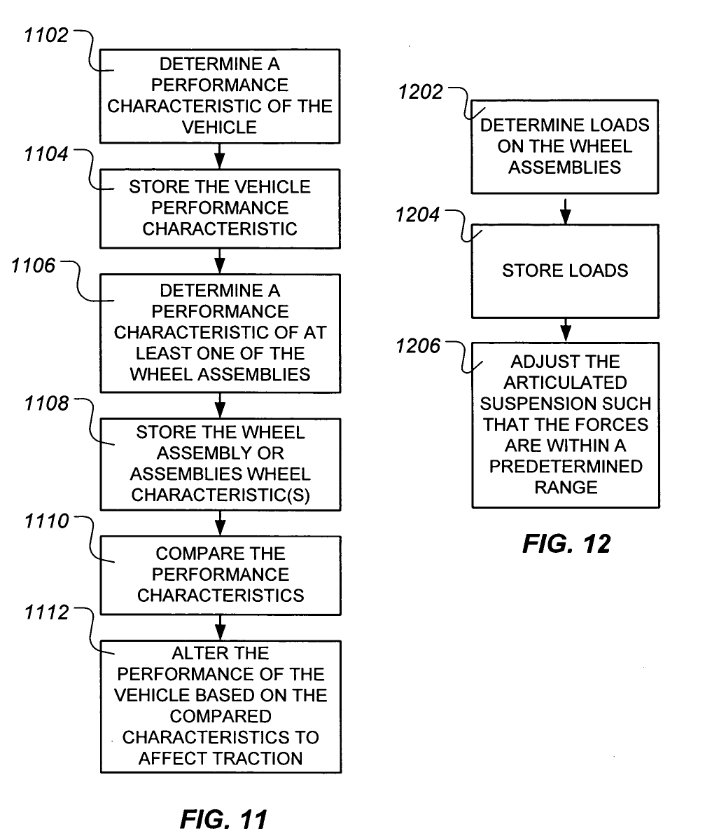

In unmanned, articulated, ground vehicles (such as the vehicle 100 of FIGS. 1A-1C) as well as in other vehicles, it is often desirable to control the vehicle's traction with respect to the terrain so that a stable, proper course and speed may be held while traversing a path or to extricate the vehicle from a traction limiting situation. Thus, according to the embodiment of the present invention illustrated in FIG. 11, a performance characteristic of the vehicle 100 is determined (block 1102) and stored (block 1104). A performance characteristic of at least one of the wheel assemblies 102 is determined (block 1106) and stored (block 1108). In some embodiments, however, the performance characteristics are not stored but, rather, are determined and used. The vehicle 100's performance characteristic and the at least one wheel assembly 102's performance characteristic are compared (block 1110). The performance of the vehicle 100 is altered based upon the comparison (in block 1110) to affect the vehicle 100's traction (block 1112).

In one embodiment, the vehicle 100's performance characteristic is the vehicle 100's velocity and the at least one wheel assembly 102's performance characteristic is the rotational velocity of the tire 410 of the at least one wheel assembly 102. In another embodiment, the vehicle 100's performance characteristic is the load on a first wheel assembly 102 and the at least one wheel assembly 102's performance characteristic is a load on at least one of the other wheel assemblies 102.

As the vehicle 100 travels, it is likely to encounter various types of terrain. For example, the terrain may be relatively homogeneous and soft, such as loose gravel or sand, or may be relatively homogeneous and hard, such as a paved surface. Alternatively, the terrain may be heterogeneous, such that it comprises both hard and soft materials. Further, for example, heterogeneous terrain may include firmly fixed rocks with loose sand, gravel, mud, or rocks disposed therebetween. Heterogeneous terrain may also include variations in terrain elevation. For example, when traversing a depression or ditch, one or more of the tires 410 may not be in contact with the terrain, resulting in a loss of traction for the one or more tires 410. Various embodiments of the method for controlling traction presented above may be used to address different terrain scenarios. Each of the exemplary scenarios will be discussed in turn.

### A. Control for Homogeneous, Soft Terrain

In driving modes over generally soft terrain, a loss of traction between a tire 410 (shown in FIG. 4) and the terrain generally means that the terrain material is being or has been displaced from under the tire 410. As terrain material is displaced, the loading on the wheel assembly 102 (shown in FIG. 4) that has lost traction may decrease. Thus, as shown in FIG. 12, a load on each of the wheel assemblies 102 of the articulated suspension is determined (block 1202) and, in some embodiments, stored (block 1204). The articulated suspension is adjusted such that at least some of the loads are within a predetermined range (block 1204).

Forces due to loading (i.e., “loads”) on the wheel assemblies 102 may be sensed in various ways. Load sensors may be attached to the suspension arms 112, torque sensors or position sensors (i.e., the encoders 420, 422 of FIG. 4B and discussed below) may be integrated into the shoulder joints 110, pressure sensors may be coupled in fluid communication with the interior of the tires 410, or other means known to the art may be used to sense the loads in the wheel assemblies 102.

One way of regaining traction is to articulate the wheel assembly 102 that has lost traction until the tire 410 is again loaded against the terrain within a predetermined force range or until odometry is consistent with the other drive mechanisms on the vehicle and/or it is within tolerances of global positioning system (“GPS”) errors. In one particular embodiment, the wheel assembly 102 is articulated with respect to the chassis 104 until the loads in the wheel assemblies 102 are level (i.e., substantially equal) and/or until the pressures of the tires 410 are level. For the purpose of this disclosure, the term “substantially equal” means equivalent within a predetermined tolerance range. Thus, if the loads are level, substantially equal, or substantially equalized, they are equivalent within a predetermined tolerance range. In this embodiment, the desired force (at which the tire 410 is loaded against the terrain) is the force at which the loads in the wheel assemblies 102 are level

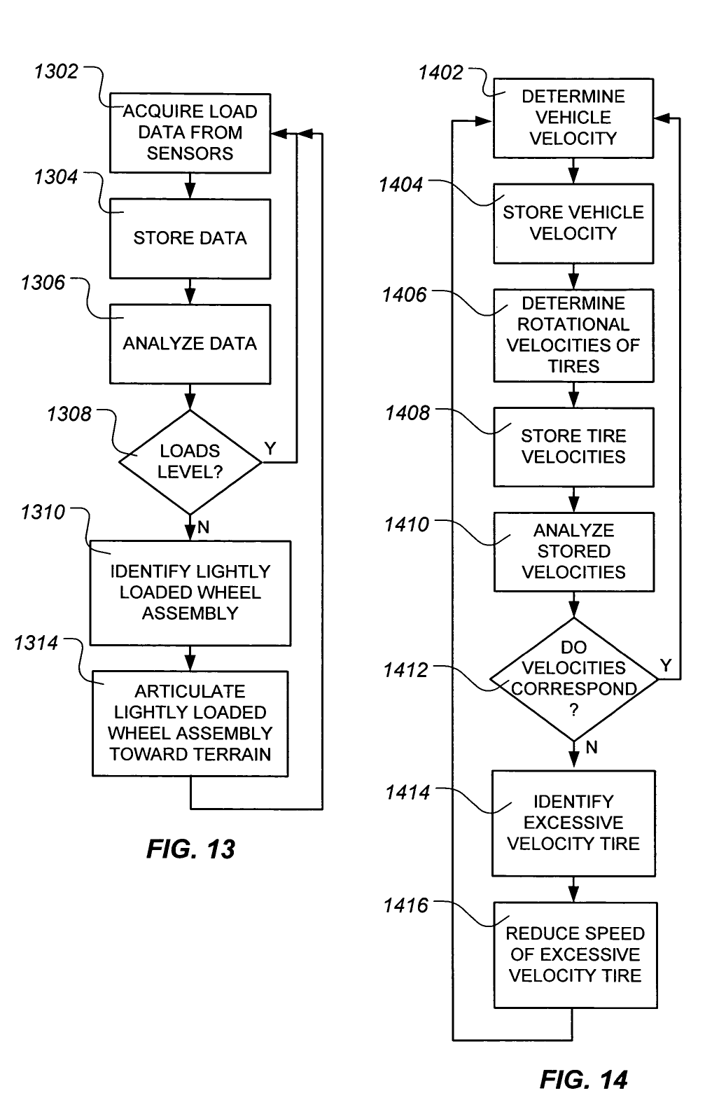

Thus, FIG. 13 depicts an illustrative embodiment of the present method of controlling the traction of an articulated vehicle on generally soft terrain. In the illustrated embodiment, load data from the sensors (e.g., load sensors, torque sensors, pressure sensors, or the like, as discussed above) is acquired (block 1302) and stored (block 1304). The stored data is analyzed (block 1306), which may include, for example, converting raw sensor data into meaningful representations of loads in the wheel assemblies 102. However, the stored, raw data may be analyzed without such a conversion. In either case, a determination is made whether the loads are level (block 1308). If the loads are level, the process is restarted. If, however, the loads are not level, the lightly loaded wheel assembly 102 is identified (block 1310) and it is articulated toward the terrain (block 1312). Control is returned to block 1302 and the process is restarted.

FIG. 13 illustrates only one wheel assembly 102 being lightly loaded and, thus, being articulated toward the terrain. The present invention, however, is not so limited. Rather, the methodology of FIG. 13 can be applied to one or more lightly loaded wheel assemblies 102. In other words, more than one lightly loaded wheel assembly 102 may be identified in block 1310 and then articulated toward the terrain in block 1312. Further, the storage operation (block 1104) may be omitted in some embodiments, such that the load data is acquired (block 1302) and analyzed (block 1306).

In addition, odometry of the wheel assembly 102, when compared to other independent drives and GPS feedback, will show variances, as discussed below concerning traction control in homogeneous, hard terrain.

### C. Control for Homogeneous, Hard Terrain

If traction is lost while traversing hard terrain, however, the tire 410 may be spinning against a firmly fixed portion of the terrain (e.g., spinning against an embedded rock). In this situation, loads on the wheel assemblies 102 may remain level even though traction is impaired.

One way of determining if the tire 410 is spinning against the terrain is to compare the velocity of the vehicle 100 to expected rotational velocities of each of the tires 410. For a given velocity of the vehicle 100, as determined by GPS and/or other rate sensors of the main chassis 104 or range readings to/from a known point via a rangefinder (not shown) or by comparison to prior on-board terrain data, each of the tires 410 should have a rotational velocity within a certain range or tolerance. If the rotational velocity of one of the tires 410 is greater than that tolerance, it can be inferred that the tire 410 is spinning against the terrain, resulting in a loss of traction between the tire 410 and the terrain.

The velocity of the vehicle 100 may be determined in many different ways. For example, the vehicle 100's velocity may be determined from distance-traveled data using simple calculus. The distance-traveled data may be extracted from odometer data, GPS data, inertial measurement unit (“IMU”) data, or the like. Velocities of each of the tires 410 can be acquired from their corresponding hub drives 114, which provide rotational velocity feedback to the vehicle control system (discussed below). The present invention, however, encompasses other means and methods known to the art for determining the velocity of the vehicle 100 and the rotational velocities of the tires 410.

FIG. 14 shows an illustrative embodiment of a method for controlling traction in an articulated vehicle on homogeneous, hard terrain. The velocity of the vehicle 100 is determined (block 1402) and stored (block 1404). The rotational velocity for each of the tires 410 is determined (block 1406) and stored (block 1408). The stored velocities are then analyzed (block 1410), which may include, for example, converting raw sensor data into meaningful representations of the vehicle 100 velocity and/or the velocities of the tires 410. However, the stored, raw data may be analyzed without such a conversion. In either case, a determination is made whether the velocity of each of the tires 410 corresponds to the vehicle 100 velocity, i.e., whether the tire velocities are within an expected range based on the vehicle 100's velocity (block 1412).

Still referring to FIG. 14, if the velocities correspond (block 1412), control is returned to block 1402 and the process is restarted, as no loss of traction has been sensed. If, however, the velocities fail to correspond (block 1412), traction has been lost. The tire 410 exhibiting excessive velocity (i.e., “over-velocity”) is identified from the stored tire velocity data (block 1422) and the speed of this tire 410 is reduced (block 1424). The speed of the over-velocity tire 410 can, in various embodiments, be reduced by braking, reducing or removing power to the tire 410, and/or regenerative braking, wherein the hub motor 702 converts the rotational kinetic energy of the tire 410 into electrical energy, which is stored for later use. Other means for reducing the speed of the over-velocity tire 410 can also be employed. Control is then returned to block 1402 and the process is restarted.

### C. Control for Heterogeneous Terrain

When a loss of traction occurs in heterogeneous terrain, it may be due to the terrain being displaced from under the tire 410 (as in homogeneous, soft terrain), it may be due to the tire 410 spinning against the terrain (as in homogeneous, hard terrain), or it may be due to frame rigidity and suspension travel limits. If terrain is being displaced from under the tire 410, the methodology discussed above for soft terrain may be employed for controlling traction. If terrain is not being displaced, the methodology discussed above for hard terrain may be employed for controlling traction. By combining these methodologies, traction may be controlled in heterogeneous terrain.

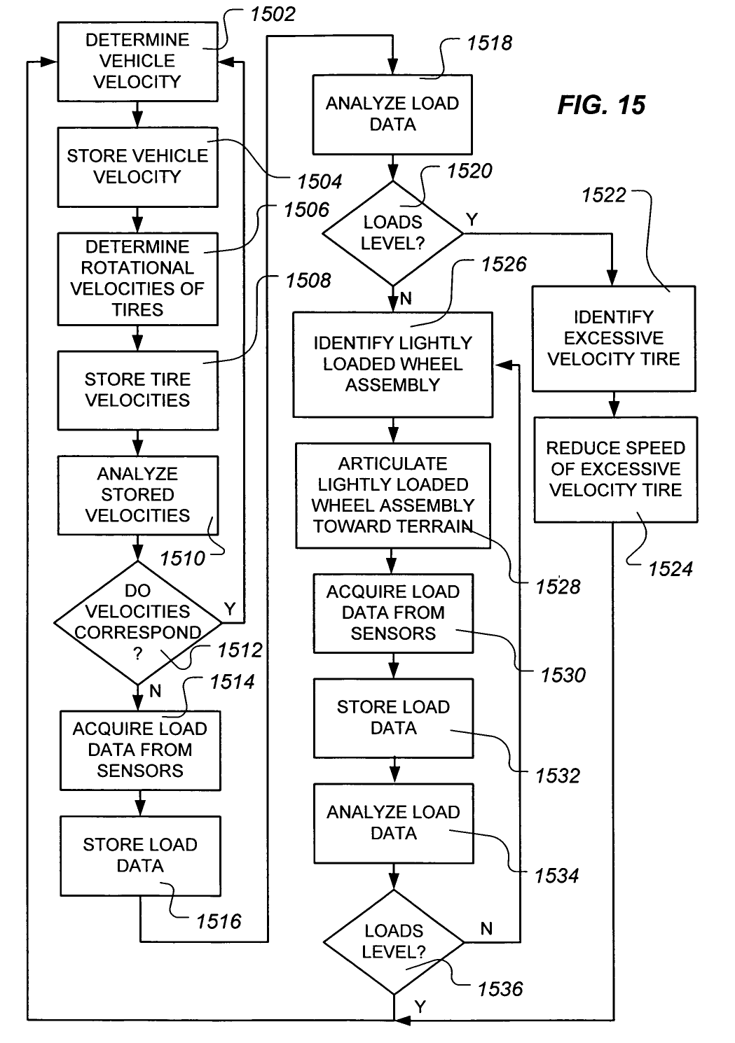

FIG. 15 shows an illustrative embodiment of a method for controlling traction in an articulated vehicle on heterogeneous terrain. The velocity of the vehicle 100 is determined (block 1502) and stored (block 1504). The rotational velocity for each of the tires 410 is determined (block 1506) and stored (block 1508). The stored velocities are then analyzed (block 1510), which may include, for example, converting raw sensor data into meaningful representations of the vehicle 100 velocity and/or the velocities of the tires 410. However, the stored, raw data may be analyzed without such a conversion. In either case, a determination is made whether the velocity of each of the tires 410 corresponds to the vehicle 100 velocity, i.e., whether the tire velocities are within an expected range based on the vehicle 100's velocity (block 1512).

Still referring to FIG. 15, if the velocities correspond (block 1512), control is returned to block 1502 and the process is restarted, as no loss of traction has been sensed. If, however, the velocities fail to correspond (block 1512), traction has been lost. To determine the cause and correction for the lost traction, load data from the sensors (e.g., load sensors, torque sensors, pressure sensors, or the like, as discussed above) is acquired (block 1514) and stored (block 1516). The stored data is analyzed (block 1518), which may include, for example, converting raw sensor data into meaningful representations of loads in the wheel assemblies 102. However, the stored, raw data may be analyzed without such a conversion. In either case, a determination is made whether the loads are level (block 1520).

If the loads are level, the loss of traction is caused by the tire 410 spinning against the terrain. The tire 410 exhibiting excessive velocity (i.e., “over-velocity”) is identified from the stored tire velocity data (block 1522) and the speed of this tire 410 is reduced (block 1524). The speed of the over-velocity tire 410 can, in various embodiments, be reduced by braking, reducing or removing power to the tire 410, and/or regenerative braking, wherein the hub motor 702 converts the rotational kinetic energy of the tire 410 into electrical energy, which is stored for later use. Other means for reducing the speed of the over-velocity tire 410 can also be employed. Control is then returned to block 1502 and the process is restarted.

If, however, the loads are not level, the loss of traction is caused by terrain material being displaced from under the tire 410. Accordingly, the lightly loaded wheel assembly 102 is identified (block 1526) and articulated toward the terrain (block 1528). To determine if traction has been re-established, load data from the sensors (e.g., load sensors, torque sensors, pressure sensors, or the like, as discussed above) is again acquired (block 1530) and stored (block 1532). The stored data is analyzed (block 1534), as discussed above, and a determination is made whether the loads are level (block 1536). If the loads are now level, control is returned to block 1502 and the process is restarted. If, however, the loads are not level, control is returned to block 1526 so that the lightly loaded wheel assembly can be articulated again toward the terrain.

### III. TRACTION CONTROL SYSTEM

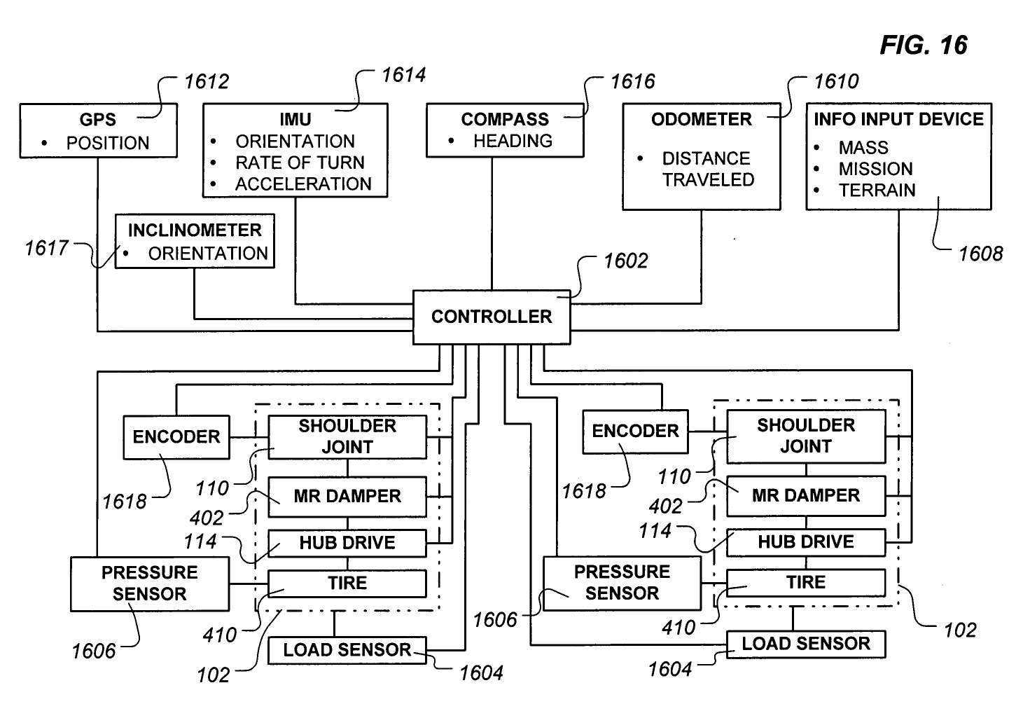

FIG. 16 provides one illustrative embodiment of a system 1600 for controlling traction in an articulated vehicle, e.g., the vehicle 100 in FIG. 1. In this embodiment, a controller 1602 is electronically coupled with various elements of the vehicle 100 such that data may be transmitted therebetween. Note that, while the vehicle 100 may include any chosen number of wheel assemblies 102, FIG. 16 depicts only two wheel assemblies 102 for clarity and so as not to obscure the invention. The controller 1602 is electrically coupled with each of the shoulder joints 110, rotary MR dampers 402, and hub drives 114 for monitoring and controlling the actions of these elements. For example, the controller 1602 outputs to a particular hub drive 114 an electrical signal corresponding to the desired velocity of the hub drive 114 and receives therefrom a signal corresponding to the actual velocity of the hub drive 114 to control its rotational velocity. Thus, by way of example and illustration, the controller 1602 is but one means for adjusting the articulated suspension system to regain traction employed in accordance with the present invention.

In the illustrated embodiment, a load sensor 1604 is coupled with each of the wheel assemblies 102 and with the controller 1602 for providing the amount of loading on each of the wheel assemblies 102 to the controller 1602. A pressure sensor 1606 is provided for each of the tires 410 so that the pressure in each of the tires 410 can be provided to the controller 1602. Thus, by way of example and illustration, the controller 1602, in combination with sensors for sensing loads in the wheel assemblies 102, is but one means for sensing a loss of traction employed in accordance with the present invention.

An input device 1608 (e.g., a user interface) allows vehicle mass, mission, terrain, and other information to be manually entered or downloaded to the controller 1602. The controller 1608 may comprise a single-board computer, a personal computer-type apparatus, or another computing apparatus known to the art. In one embodiment, the system 1600 includes an odometer 1610 that provides distance-traveled data to the controller 1602. In this embodiment, the controller 1602 is a proportional-integral-derivative (“PID”) controller, which is adapted to calculate the velocity and acceleration of the vehicle based on data from the odometer 1610. In other embodiments, the velocity and acceleration, if needed for controlling the attitude of the vehicle 100, may be provided by other means, such as by using data from a GPS receiver or an IMU. Based on data provided by these sensors, the controller 1602 effects control over the traction of the vehicle 100 according to the methods described above.

In the illustrated embodiment, the system 1600 further includes a GPS receiver 1612 adapted to provide the position of the vehicle 100 based on satellite triangulation to the controller 1602. The system 1600 may further include an IMU 1614 for providing orientation, rate of turn, and/or acceleration data to the controller 1602. In some embodiments, the IMU may be used as a redundant system for determining the location of the vehicle 100 in the case of failure of the GPS receiver 1612. The illustrated embodiment also includes a compass 1616 for providing heading information to the controller 1602 and may include an inclinometer 1617.

It may be desirable in some embodiments for the controller 1602 to have knowledge of the articulated location of each of the wheel assemblies 102 with respect to the chassis 104. Therefore, one embodiment of the present invention includes a plurality of encoders 1618 corresponding to the plurality of wheel assemblies 102. The embodiment illustrated in FIG. 4B employs an arm position encoder 420 and a torsion bar twist encoder 422 to acquire data regarding the position of the arm 304 and the twist on the torsion bar assembly 310, respectively. From this data, the controller 1602 can determine the arm speed, arm reaction torque, and estimated suspension load for the shoulder joint 210. Alternatively, resolvers or potentiometers may be used to measure for this information. Note that some embodiments may integrate a tachometer and calculate the same position data using simple calculus.

It will be appreciated by one of ordinary skill in the art having benefit of this disclosure that other means may be used to determine information needed to control the traction of the vehicle 100, 1700. Further, the scope of the present invention encompasses various embodiments wherein not every wheel assembly 102, 1702 of the vehicle 100, 1700 is controlled according to the traction control methodologies disclosed above. While the embodiments disclosed herein are implemented in an electronic control system, other types of control systems are within the scope of the present invention.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of controlling traction in a vehicle having an articulated suspension, comprising:
determining a performance characteristic of the vehicle;
determining a performance characteristic of at least one of a plurality of wheel assemblies of the articulated suspension;
comparing the performance characteristic of the vehicle and the performance characteristic of the at least one of the plurality of wheel assemblies; and
altering the performance of the vehicle based upon the comparison to affect the vehicle's traction.

2. A method, according to claim 1, wherein:
determining the performance characteristic of the vehicle comprises determining a velocity of the vehicle; and
determining the performance characteristic of the at least one of the plurality of wheel assemblies comprises determining a rotational velocity of the at least one of the plurality of wheel assemblies.

3. A method, according to claim 1, wherein:
determining the performance characteristic of the vehicle comprises a load on a first of a plurality of wheel assemblies; and
determining the performance characteristic of the at least one of the plurality of wheel assemblies comprises a load on another one or more of the plurality of wheel assemblies.

4. A method of controlling traction in a vehicle having an articulated suspension, comprising:
determining a load on each of a plurality of wheel assemblies of the articulated suspension; and
adjusting the articulated suspension such that each of the loads is within a predetermined range.

5. A method, according to claim 4, wherein determining the load comprises sensing a load on each suspension arm of the plurality of wheel assemblies.

6. A method, according to claim 4, wherein determining the load comprises sensing a pressure of each tire of the plurality of wheel assemblies.

7. A method, according to claim 4, wherein adjusting the articulated suspension comprises adjusting the articulated suspension to substantially equalize the loads.

8. A method, according to claim 4, wherein adjusting the articulated suspension comprises articulating at least one of the plurality of wheel assemblies with respect to a chassis of the vehicle.

9. A method, according to claim 4, further comprising determining a lightly loaded wheel assembly of the plurality of wheel assemblies, such that adjusting the articulated suspension comprises articulating the lightly loaded wheel assembly with respect to a chassis of the vehicle.

10. A method of controlling traction in a vehicle having an articulated suspension, comprising:
acquiring load data for a plurality of wheel assemblies of the articulated suspension;
identifying a lightly loaded wheel assembly of the plurality of wheel assemblies from the load data; and
articulating the lightly loaded wheel assembly with respect to a chassis of the vehicle.

11. A method, according to claim 10, wherein acquiring the load data comprises sensing a load on each suspension arm of the plurality of wheel assemblies.

12. A method, according to claim 10, wherein acquiring the load data comprises sensing a pressure of each tire of the plurality of wheel assemblies.

13. A method, according to claim 10, wherein articulating the lightly loaded wheel assembly comprises articulating the lightly loaded wheel assembly to substantially equalize the load on each of the plurality of wheel assemblies.

14. A method of controlling traction in a vehicle having an articulated suspension, comprising:
determining whether forces on each of a plurality of wheel assemblies of the articulated suspension are substantially equal;
determining whether a rotational velocity of each tire of the plurality of wheel assemblies corresponds to a velocity of the vehicle; and
adjusting the articulated suspension such that each of the forces is within a predetermined range if the forces are not substantially equal and at least one of the rotational velocities fails to correspond to the velocity of the vehicle.

15. A method, according to claim 14, wherein determining whether forces on each of a plurality of wheel assemblies of the articulated suspension are substantially equal comprises sensing a load on each suspension arm of the plurality of wheel assemblies.

16. A method, according to claim 14, wherein determining whether forces on each of a plurality of wheel assemblies of the articulated suspension are substantially equal comprises sensing a pressure of each tire of the plurality of wheel assemblies.

17. A method, according to claim 14, wherein adjusting the articulated suspension comprises adjusting the articulated suspension to substantially equalize the forces.

18. A method, according to claim 14, wherein adjusting the articulated suspension comprises articulating at least one of the plurality of wheel assemblies with respect to a chassis of the vehicle.

19. A method, according to claim 14, further comprising determining a lightly loaded wheel assembly of the plurality of wheel assemblies, such that adjusting the articulated suspension comprises articulating the lightly loaded wheel assembly with respect to a chassis of the vehicle.

20. A method, according to claim 14, further comprising reducing the rotational velocity of one of the tires if the forces are substantially equal and the one of the tires has a determined rotational velocity that is greater than that which corresponds to the velocity of the vehicle.

21. A method, according to claim 20, wherein reducing the rotational velocity comprises reducing the rotational velocity of the tire by braking.

22. A method, according to claim 20, wherein reducing the rotational velocity comprises reducing the rotational velocity of the tire by at least partially removing power to the tire.

23. A method, according to claim 20, wherein reducing the rotational velocity comprises reducing the rotational velocity of the tire by regenerative braking.

24. A method of controlling traction in a vehicle having an articulated suspension, comprising:
determining whether a rotational velocity of each tire of a plurality of wheel assemblies of the articulated suspension corresponds to a velocity of the vehicle; and
reducing the rotational velocity of one of the tires if the one of the tires has a determined rotational velocity that is greater than that which corresponds to the velocity of the vehicle.

25. A method, according to claim 24, wherein reducing the rotational velocity comprises reducing the rotational velocity of the tire by braking.

26. A method, according to claim 24, wherein reducing the rotational velocity comprises reducing the rotational velocity of the tire by at least partially removing power to the tire.

27. A method, according to claim 24, wherein reducing the rotational velocity comprises reducing the rotational velocity of the tire by regenerative braking.

28. A system for controlling traction in an vehicle having an articulated suspension, comprising:
means for sensing a loss of traction; and
means for adjusting the articulated suspension to regain traction.

29. A system, according to claim 28, wherein:
the articulated suspension comprises a plurality of wheel assemblies; and
the means for sensing the loss of traction comprises:
a plurality of sensors for sensing loads in a plurality of wheel assemblies; and
a controller for receiving the sensed loads and to determine the loss of traction based on the sensed loads.

30. A system, according to claim 29, wherein the means for sensing the loss of traction further comprises at least one of an odometer, a global positioning system receiver, an inertial measurement unit, a compass, and an inclinometer.

31. A system, according to claim 29, wherein the plurality of sensors is adapted to sense loads in suspension arms of the plurality of wheel assemblies.

32. A system, according to claim 29, wherein the plurality of sensors is adapted to sense air pressure in tires of the plurality of wheel assemblies.

33. A system, according to claim 28, wherein the means for adjusting the articulated suspension comprises the controller, which determines adjustments to be made to the articulated suspension to regain traction and transmits commands corresponding to the adjustments to the articulated suspension system.

34. A system, according to claim 33, wherein:
the articulated suspension comprises a plurality of wheel assemblies;
the vehicle comprises a chassis to which the plurality of wheel assemblies is articulated; and
the control system articulates one or more of the plurality of wheel assemblies with respect to the chassis to regain traction.

35. A system, according to claim 33, wherein:
the articulated suspension comprises a plurality of tires; and
the control system reduces the rotational velocity of one or more of the plurality of tires to regain traction.

36. A vehicle, comprising:
a chassis;
an articulated suspension mounted to the chassis;
means for sensing a loss of traction; and
means for adjusting the articulated suspension to regain traction.

37. A vehicle, according to claim 36, wherein: the articulated suspension comprises a plurality of wheel assemblies; and
the means for sensing the loss of traction comprises:
a plurality of sensors for sensing loads in a plurality of wheel assemblies; and
a controller for receiving the sensed loads and to determine the loss of traction based on the sensed loads.

38. A vehicle, according to claim 37, wherein the means for sensing the loss of traction further comprises at least one of an odometer, a global positioning system receiver, an inertial measurement unit, a compass, and an inclinometer.

39. A vehicle, according to claim 37, wherein the plurality of sensors is adapted to sense loads in suspension arms of the plurality of wheel assemblies.

40. A vehicle, according to claim 37, wherein the plurality of sensors is adapted to sense air pressure in tires of the plurality of wheel assemblies.

41. A vehicle, according to claim 36, wherein the means for adjusting the articulated suspension comprises the controller, which determines adjustments to be made to the articulated suspension to regain traction and transmits commands corresponding to the adjustments to the articulated suspension vehicle.

42. A vehicle, according to claim 41, wherein:
the articulated suspension comprises a plurality of wheel assemblies; and
the control vehicle articulates one or more of the plurality of wheel assemblies with respect to the chassis to regain traction.

43. A vehicle, according to claim 41, wherein:
the articulated suspension comprises a plurality of tires; and
the control vehicle reduces the rotational velocity of one or more of the plurality of tires to regain traction.
